(19) United States
(12) Patent Application Publication
(10) Pub. No.: US 2014/0151274 A1
(43) Pub. Date: Jun. 5, 2014

(54) Hydrocyclone With Wear Detector

(71) Applicants: David Hadfield, Sussex (GB); Ian Charles Smyth, Hampshire (GB)

(72) Inventors: David Hadfield, Sussex (GB); Ian Charles Smyth, Hampshire (GB)

(73) Assignee: M-I DRILLING FLUIDS UK LIMITED, Aberdeen (GB)

(21) Appl. No.: 13/996,524

(22) PCT Filed: Dec. 19, 2011
(86) PCT No.: PCT/GB2011/052518

§ 371 Date: Oct. 25, 2013

(30) Foreign Application Priority Data
Dec. 20, 2010 (GB) 1021528.3

(51) Int. Cl. B04C 11/00; G01N 17/00

(52) U.S. Cl. CPC B04C 11/00; G01N 17/00
USPC 210/85; 73/86

(57) ABSTRACT

A wear detector comprising, a pressure vessel, a hydrocyclone, within the pressure vessel, a vibration or strain sensor, coupled to the hydrocyclone, for producing a data signal representative of a physical parameter of the hydrocyclone, means for transmitting the data signal out of the pressure vessel, and data analysing means, for collecting and analysing the data signal.

This invention relates to condition monitoring or the detection of wear in hydrocyclones. More specifically, this invention relates to the non-invasive detection of wear in hydrocyclones by use of vibration or strain sensors. It should be understood that the term hydrocyclone is used to include any cyclonic separator in which the continuous phase is a fluid, whether compressible or incompressible.

In the oil and gas industry, hydrocyclones are commonly employed in pressurised separator vessels to separate solids, liquids and gas produce from oil and gas wells. The separator is typically positioned near an oil/gas well but may be in a remote location, offshore or even deep underwater.

During operation, hydrocyclones can experience wear due to abrasive particles (e.g. sand) eroding the hydrocyclone's internal wall. This wear can lead to inefficiencies and ultimately to failure of the hydrocyclone.

Once fitted inside a pressure vessel, it is difficult to inspect hydrocyclones for such wear. Inspection involves shutting the pressure vessel down and opening the vessel. This is time consuming and is expensive, since it may interrupt platform operation. Alternatively, a regular replacement schedule may be used. However, to avoid any unexpected failures taking place, the replacement schedule will necessarily be conservative meaning that hydrocyclones may be needlessly replaced before a full hydrocyclone operational lifetime has been achieved. Accordingly, this alternative may cause operational delays more frequently than necessary and may result in unnecessarily early replacement of components. The impact of such situations is more severe when the separator is located in a remote or inaccessible location.

Desirably therefore, a means of predicting and/or assessing hydrocyclone wear without operational interruptions is required.

U.S. Pat. No. 4,092,848 discloses an apparatus and method for detecting wear in hydrocyclones. U.S. '848 discloses a long, thin member, for insertion into a hydrocyclone, including a truncated conical section. When the member is inserted into the overflow section of a hydrocyclone, the truncated conical section becomes flush with the interior wall of the hydrocyclone, and a portion of the member extends a distance out of the underflow section of the hydrocyclone. The wear of the interior wall is determined by measurement of the distance between the end of the member and the point of the member corresponding to a periphery of the underflow section of the hydrocyclone.

There are problems associated with this apparatus. U.S. '848 discloses a manual, invasive apparatus and method. Therefore, for the internal wear of the hydrocyclone to be measured, the hydrocyclone must be shut down, and an operator must manually insert the apparatus into the hydrocyclone. This method therefore results in downtime, and is not suitable when the hydrocyclone is in an inaccessible location such as inside a pressure vessel or at a remote location.

U.S. Pat. No. 6,945,098 also discloses apparatus for the detection of wear in hydrocyclones. This invention relates to a thin body of insulating material, including an electrically conducting wire. The body is placed between two sections of a hydrocyclone, or placed across a wall of the hydrocyclone, and experiences the same causes of erosion as the interior wall of the hydrocyclone. The electrical current applied to the wire is monitored, and changes in conductivity or continuity are assumed to indicate wear of the body, and therefore, wear of the hydrocyclone interior wall.

There are also problems associated with this apparatus. U.S. '098 discloses apparatus which must be built into the hydrocyclone. This is therefore difficult to retrofit to existing hydrocyclones, particularly those in inaccessible locations. A further problem with this apparatus is that it relies on the electrical characteristics of the material flowing through the hydrocyclone. In practice this characteristic is variable in an unpredictable way. Such variability directly impacts on accuracy of the “wear” measurement and thus no progressive wear rate is determinable. Once the wire has failed in the predicted way, there is a step change in the output reading and no accurate warning of impending failure. The wires may be buried at several different layers but in practice this provides a very poor resolution of progressive measurement. It is also difficult to manufacture and highly invasive in that the structure and material properties of the cyclone are significantly altered by the embedding of wire and insulator into extensive parts and depths of the wall material.

Some work has also been carried out on generic measurement of structural characteristics in flowing structures as set out below.

U.S. Pat. No. 4,111,040 discloses a device for the detection of corrosion of the internal wall of a metal chamber, preferably for detecting corrosion on the internal wall of conduits for transporting hydrocarbons which are buried in, or on, the sea floor. The device comprises at least one transducer, e.g. a strain sensor, for measuring the increased strain in the conduit wall as it stretches due to wear-related thinning. There is no measurement of vibrational characteristics of the conduit. The disclosure is primarily concerned with protecting the strain sensor from water ingress to avoid any subsea maintenance requirements.

US Patent Application Publication Number 2005/0103123 A1 discloses a system for measuring parameters of a structure, such as a tubular member, including a plurality of strain gauges placed on the structure. The strain gauges are for providing axial strain measurements and not for wear detection. A computer apparatus for receiving signals from the strain gauges determines the bending moment and bending direction of the structure. The measurements are static strain measurements and no frequency spectral analysis or vibrational analysis is proposed.

UK Patent Publication Number 2254425 A discloses a defect detecting method comprising vibrating the object to be measured, picking up the vibration, and detecting that a spectrum of the characteristic vibration of the object to be measured has a portion which is separated into two peaks. The type of defect is indicated by the position of extra peaks in the spectrum in the first or second order main energy peaks. The technique relies on a known input energy characteristic and is not used for measuring parts in use. It is intended for detecting faults, such as casting defects, in new parts of automotive internal combustion engines in a controlled environment, such as on a production line before engine assembly.

U.S. Pat. No. 4,901,575 discloses a method and apparatus for monitoring the structural acoustic signature of a structural member such as a bridge in response to a transient load such as a lorry passing over the member. The vibrational information is detected by accelerometers placed on the structural member and is preferably evaluated in the frequency domain. The system is used to determine the nature and type of load passing over the member and in particular to look for overweight or speeding vehicles.

US Patent Application Publication Number 2008/0082296 A1 discloses a low power vibration sensor and wireless transmitter system. The vibrations picked up by the vibration sensor are locally processed before wireless transmission to a control protocol network. The power consumption of the system can therefore be reduced. This disclosure is limited to signal sampling, processing and transmission in order to compress the data to save power. No detail of the type of apparatus to be measured, the type of analysis to be carried out or the purpose of such measurement is provided.

U.S. Pat. No. 7,430,914 discloses a vibration analysing device for determining the vibrational response of a structural element. The disclosure proposes classifying the condition of the element according to three possible classifications based on the output of an accelerometer. The accelerometer is arranged to provide an output in response to a force input to the structural element. The innovation is to use a single RMS velocity value over the entire analysis range in order to classify the condition of the structural element into “OK”, “concern” or “problem” classes based on a simple threshold.

International publication No. 01/03840 A1 discloses a system for monitoring and analysing surface vibration waves generated by the operation of material processing equipment such as a SAG mill. The high-energy collisions of grinding media inside the SAG mill produce acoustically measurable surface waves, which may be monitored and analysed for process characterization. This method is not, however, suitable for wear detection in hydrocyclones in a pressure vessel, as acoustic techniques are inappropriate due to low acoustic output of the hydrocyclone, and (when the pressure vessel is flooded) the dampening effect of the surrounding fluid.

According to a first aspect of the invention, there is provided a wear detector arranged to detect wear in a hydrocyclone in a pressure vessel, comprising a strain gauge mounted to the hydrocyclone and arranged to sense vibration of the hydrocyclone in use, and a signal processor coupled to the strain gauge and arranged to sample the strain gauge output to provide strain gauge data representative of the vibration experienced by the strain gauge as fluid flows through the hydrocyclone, the signal processor being further arranged to generate a current frequency signature for the hydrocyclone by analysing the strain gauge data to determine the energy density in a plurality of vibrational frequency bands, to provide an indication of the degree of wear on the internal surfaces of the hydrocyclone.

Embodiments of the invention will now be described, by way of example, and with reference to the drawings in which:

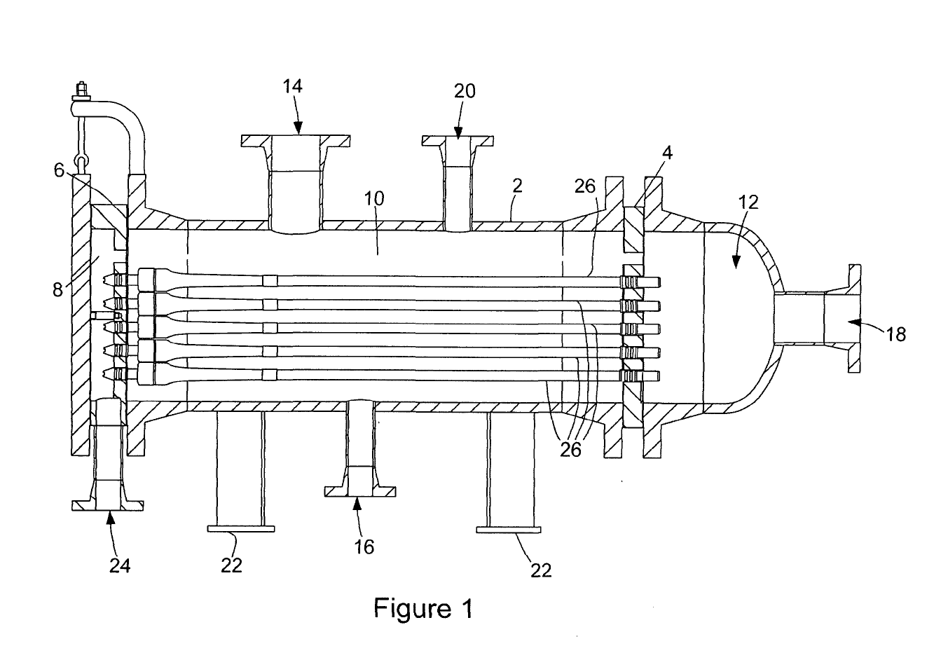

FIG. 1 is a section of a separator of the present invention;

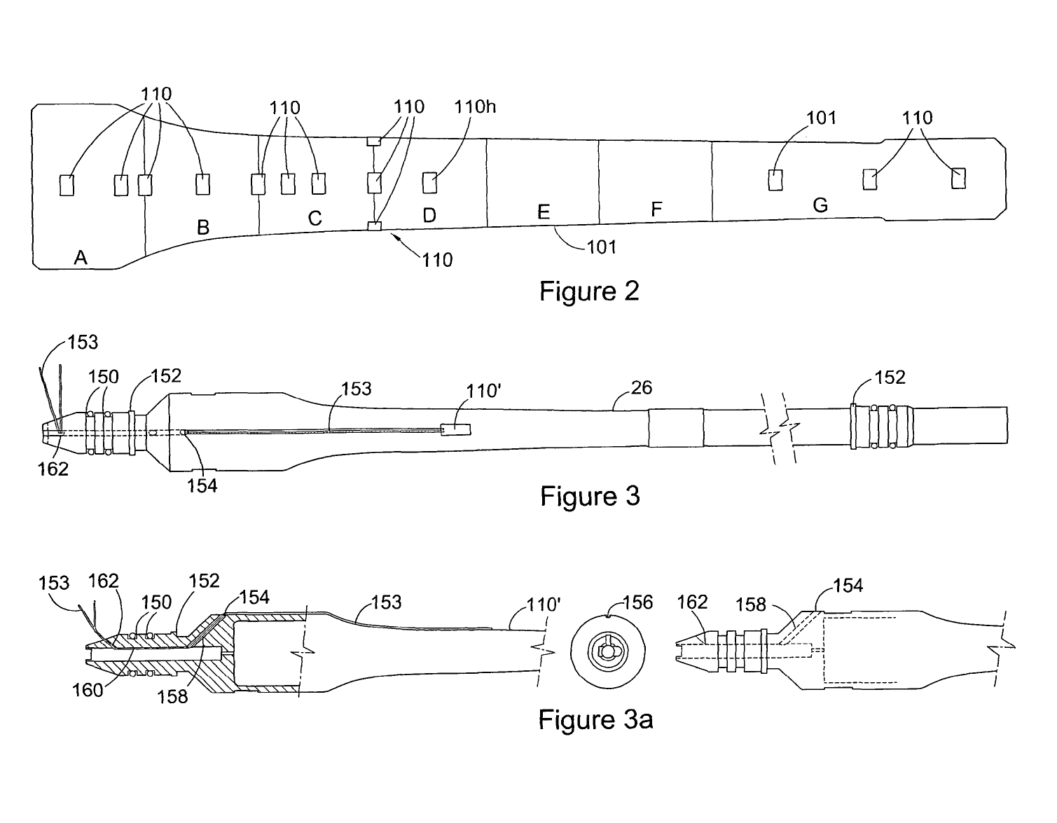

FIG. 2 shows one possible arrangement of strain gauges on the taper section of the hydrocyclone of FIG. 1;

FIG. 3 is an elevation of a hydrocyclone, showing an arrangement for transmitting a data signal out of the pressure vessel;

FIG. 3A is a set of further elevations and a section of the hydrocyclone of FIG. 3;

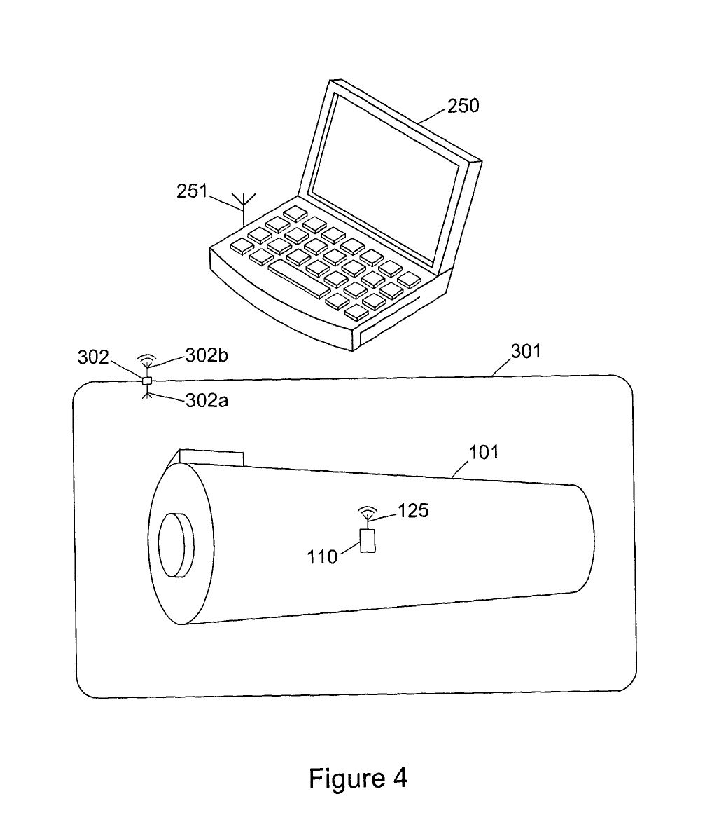

FIG. 4 is a schematic block diagram showing a further arrangement for transmitting a data signal out of the pressure vessel;

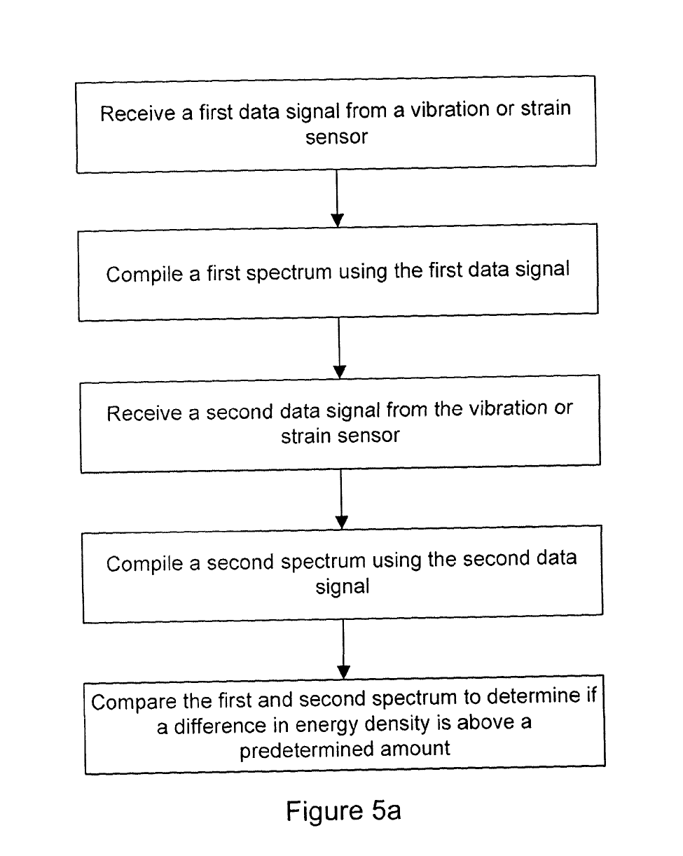

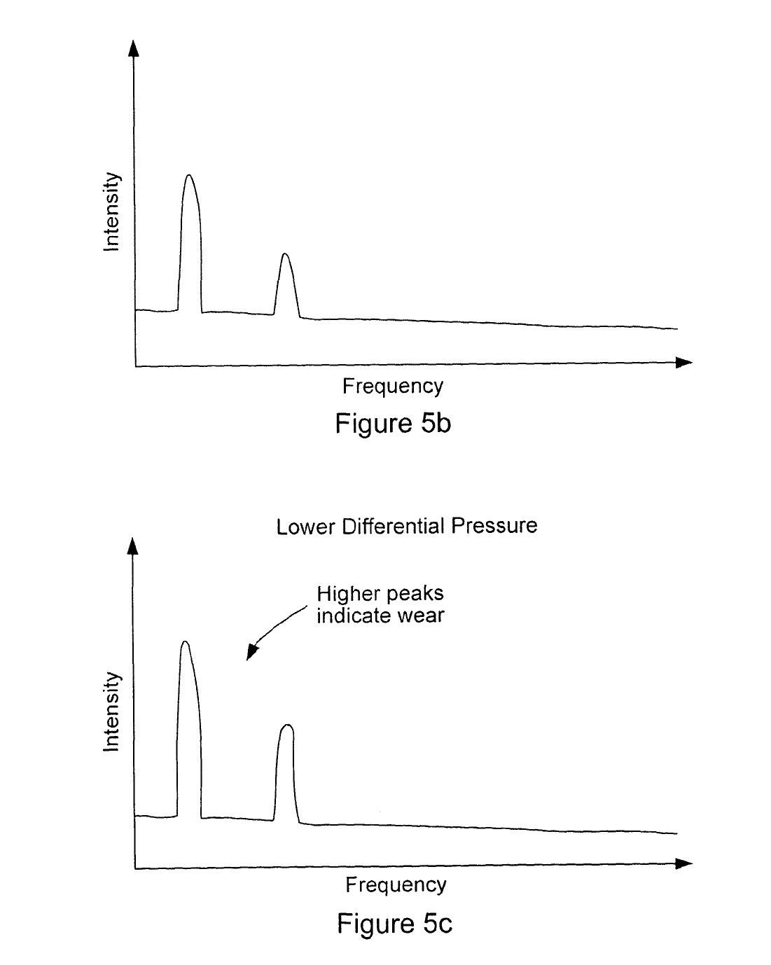

FIG. 5a is a flowchart of a first possible method of data analysis;

FIG. 5b is a plot of a frequency spectrum compiled from a data signal from a new or substantially unworn hydrocyclone at a low differential pressure;

FIG. 5c is a plot of a frequency spectrum compiled from a data signal from an eroded hydrocyclone at a low differential pressure;

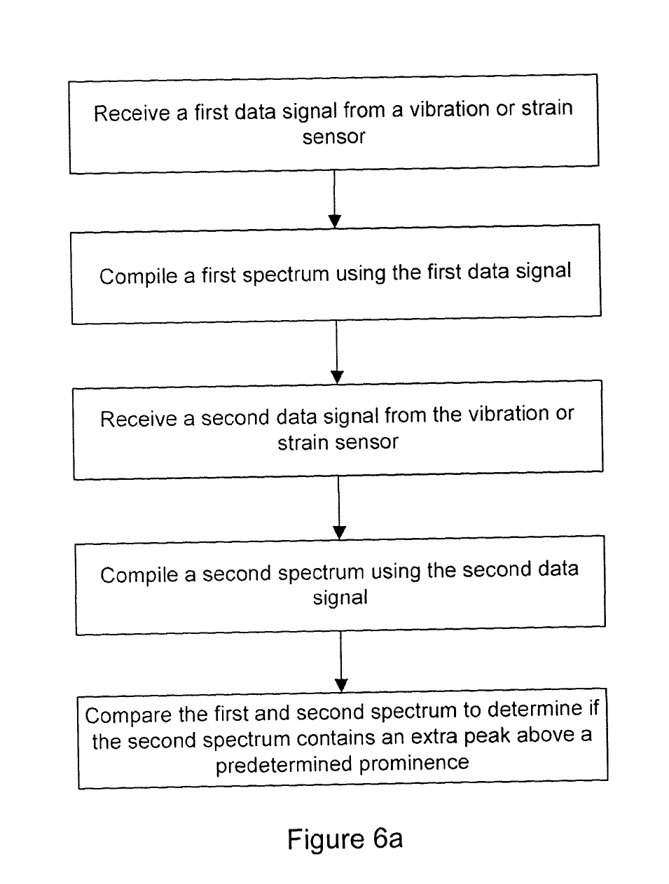

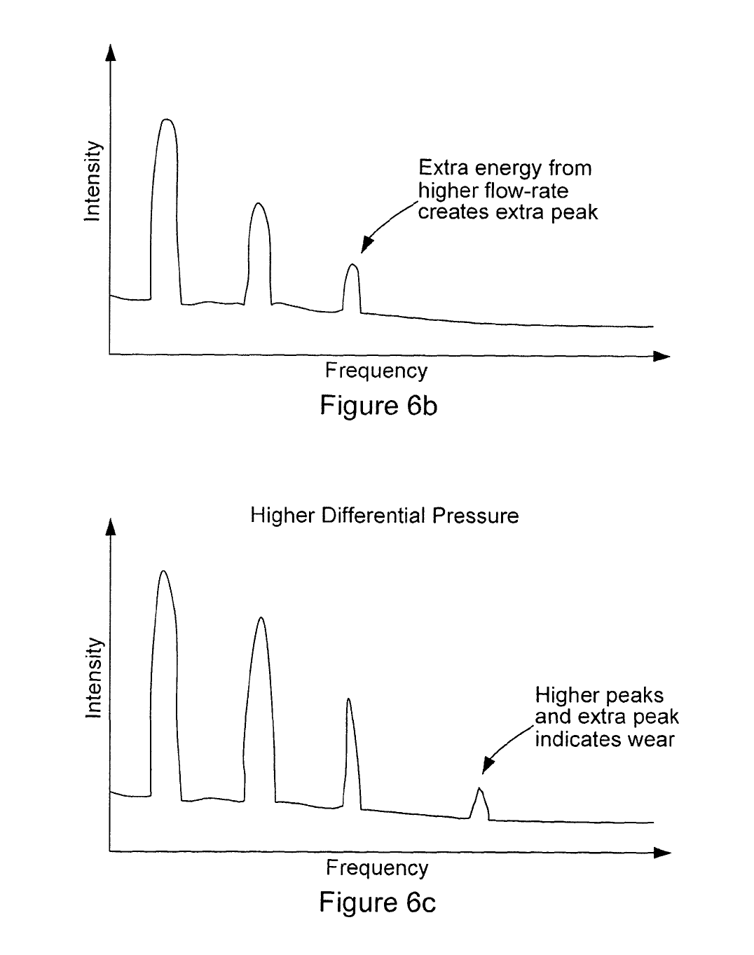

FIG. 6a is a flowchart of a second method of data analysis;

FIG. 6b is a plot of a frequency spectrum compiled from a data signal from a new or substantially unworn hydrocyclone at a high differential pressure;

FIG. 6c is a plot of a frequency spectrum compiled from a data signal from an eroded hydrocyclone at a high differential pressure;

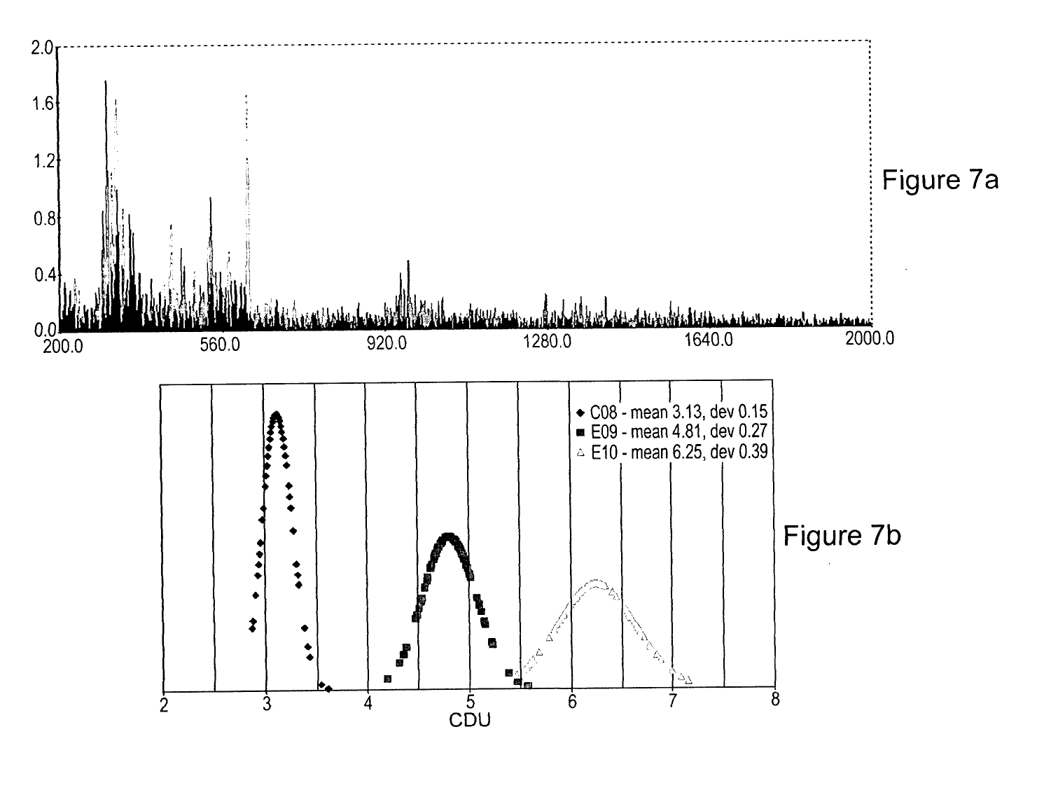

FIG. 7a illustrates experimental data produced in the Applicant's research; and

FIG. 7b illustrates a plot of Cyclone Damage Unit values based on the data of FIG. 7a.

With reference to FIG. 1, a separator comprises a pressure vessel 2 which is very generally tubular in shape and has an underflow plate 4 and an overflow plate 6 dividing the vessel effectively into three chambers; an overflow chamber 8, an inlet chamber 10 and an underflow chamber 12.

The vessel is provided with an oily water inlet 14, a drain 16 and a clean water underflow outlet 18. Preferably also the vessel has a vent 20. The vessel is typically rigidly attached to an oil or gas platform via feet 22.

Finally, the vessel has an oily water outlet 24 coupled to the overflow chamber 8.

Oily water is introduced into the separator through the oily water inlet 14 and is caused to circulate through a plurality of hydrocylones 26 mounted within the separator and arranged such that the overflow, inlet and underflow ports of the hydrocylones are coupled to the respective overflow, inlet and underflow chambers in the vessel. Thus oily water introduced into the inlet 14 is spun through the plurality of hydrocylones in a manner known in the art, causing separation to occur so that clean water gathers in the underflow chamber 12 and exits through the clean water outlet 18.

As discussed above, the oily water introduced into the inlet 14 typically carries a proportion of solids such as sand. Over time and due to the relatively high velocities and directional changes experienced by the solids within the hydrocylones 26, the solids cause wear on the inner surfaces of the hydrocylones. The techniques described below are intended to allow a determination of that degree of wear without needing to disassemble the separator to visually inspect or manually measure the condition of the hydrocyclones 26.

With reference to FIG. 3, a hydrocyclone 101 is a liquid-liquid hydrocyclone with an aspect ratio between 10:1 and 40:1. More preferably, the aspect ratio of the hydrocyclone 101 is between 20:1 and 30:1; the aspect ratio being taken as the widest internal dimension of the hydrocylcone to its length. This type of hydrocyclone may be inserted in the position shown as 26 in FIG. 1.

The hydrocyclone 101 includes a plurality of strain gauges 110 mechanically coupled to the exterior of the hydrocyclone 101, for producing a data signal representative of the strain of the hydrocyclone 101. The strain gauges 110 are in one embodiment, mild steel foil strain gauges. In this embodiment, the strain gauges 110 are coupled to the exterior surface of the hydrocyclone 101 by a suitable adhesive, such that the surface of the strain gauge 110 is generally flush with the exterior of the hydrocyclone 101.

A single strain gauge per hydrocyclone could be used but by including a plurality of strain gauges, the design is made more robust by providing additional redundancy. Also, comparative readings between the plurality of gauges allows for self-diagnostic capability by allowing the identification of anomalous readings from a failing strain gauge. Furthermore, the vibrational characteristics of a hydrocylcone may vary due to manufacturing tolerance and also in-use wear meaning that the optimum positioning for the strain gauge (which will typically be a place of maximum amplitude vibration) may vary across batches of hydrocylcones and over time. Use of several strain gauges allows a choice of positioning so that at least one of the gauges will be positioned generally at a place of high amplitude vibration.

Alternatively the strain gauges 110 may be thick film, force sensitive resistors or another form e.g. semi-conductor based. Suitable thick film gauges are disclosed in U.S. Pat. No. 6,378,384 (Atkinson et al) and GB-A-2310288 (Atkinson et al). However, although strain gauges are discussed below, it will be understood that magnetoresistive or piezoresistive devices or accelerometers are also suitable. The thick film, piezoresistive gauges are preferred because of their ruggedness combined with sensitivity. Nevertheless any transducer which meets the ruggedness and sensitivity requirements and is able to provide some measure of movement of the hydrocyclone walls, is suitable for this invention.

The positioning of the strain gauges 110 is determined according to the particular hydrocyclone 101, its purpose, and its environment and some options are described below. The skilled reader will understand that each strain gauge 110 is optimally positioned such that there is a discernable difference in the captured data from the strain gauge 110 between good and eroded hydrocyclones 101. For the purposes of this description a good hydrocyclone 101 is one in which there is little or no erosion of its internal wall, and which is therefore performing at an optimal or near optimal efficiency and an eroded hydrocyclone 101 is one in which the erosion of its internal wall has caused a discernable efficiency drop, or has caused the structural integrity of the hydrocyclone 101 to be compromised.

Whilst it will be appreciated that one strain gauge on a hydrocyclone provides a useful reading for the present invention and is intended to be encompassed in its scope, it is anticipated that multiple strain gauges will be applied to a hydrocyclone. This allows for distribution both axially and circumferentially around the hydrocyclone which takes account of the complex resonant modes of the structure which typically include axial, circular and helical components. Also, the orientation of the gauges should be selected to measure strain in different, preferably high amplitude, directions. The general requirement is to choose positions and orientations which provide a strong vibrational output against the background environmental noise.

Various parameters determine where the strain gauges 110 should be placed. Such parameters include the dimensions of the hydrocyclone 101, the mixture to be introduced into the hydrocyclone 101, its materials of construction and the characteristics of the process medium both within and around the hydrocyclone 101.

During operation, the kinetic energy in fluid flowing through the hydrocyclone imparts vibrational energy to the hydrocyclone. This sets up resonances in the hydrocyclone structure and optimally, the strain gauges 110 should be placed where the amplitude of vibration is a maximum. The positioning should ideally allow for placement at antinodes of higher order harmonics as well as the lower or lowest orders This is because higher flow rates within the hydrocyclone 101 have, through the applicant's research, been found to produce stronger strain gauge responses at higher orders so that the region of interest shifts up the frequency spectrum with increasing flow rate. The strain gauges may be aligned across or along the axis of the hydrocyclone and may be positioned between these extremes so that strain is sensed simultaneously both axially and circumferentially by the strain gauge. A plurality of gauges may be located in a combination of orientations, however, since the hydrocyclones tend to produce higher amplitude flexion along their length, an axial strain determination typically produces the most sensitive arrangement. Generally, however, hydrocyclone vibration will be complex and a further basis for identifying where best gauge response can be anticipated is by positioning where preferential wear is expected.

FIG. 2 shows one possible distribution of strain gauges. For clarity the hydrocyclone taper section is notionally split into different sections, A to G. Strain gauges, 110, are placed close to the inlet of the hydrocyclone 101 and distributed approximately evenly though sections A to D. A second set of strain gauges 110 are arranged in section G towards the underflow outlet end of the hydrocyclone taper section.

Although not fully visible in the Figure, further strain gauges 110 are placed on the border of section C and D at 90 degree steps around the axis of the hydrocyclone 101. Thus, four strain gauges 110 are placed at regular intervals around the axis of the hydrocyclone 101 on the border of sections C and D.

Any suitable water/hydrocarbon proof and pressure resistant material will serve for securing and protecting the strain gauges. For example a 2 or 3-pack epoxy material could be used. This step is not essential for thick film strain gauges which are printed on the hydrocyclone surface, since they are inherently well-secured to the hydrocyclone body and may be electrically isolated using subsequent printed layers. Nevertheless, such materials may be used to overlay such gauges and/or to protect and/or secure wired connections to the gauges.

The strain gauge output may be wired out of the vessel for signal conversion, processing and analysis or this may be achieved locally via an application specific IC (ASIC) mounted on or near each hydrocyclone, which could also be used to multiplex together outputs from more than one gauge. The resulting “smart” or “intelligent” hydrocyclone may be used in a modular fashion to build up a condition monitored pressure vessel. The ASIC may also contain a serial number for the hydrocyclone and other hydrocyclone-specific parameters which may allow for improved parts tracking, condition monitoring and auditing. Furthermore, the ASIC may include communication means, such as wireless means for sending data in real-time or in batched, locally stored sets of data. The ASICs may create a mesh or daisy chained network for example using an IEC 61158 “Fieldbus” type network communications protocol, such as Foundation Fieldbus, and, for example, twisted pair connections. The short range communications from the hydrocylones may also be transmitted using a low-power wireless transmission for example, using an IEEE 802.15.4 (Zigbee) compliant protocol.

With reference to FIGS. 3 and 3A, a hydrocyclone of a type shown in FIGS. 1 and 2 is shown in detailed form. The hydrocyclone 26 has a piezoresistive strain gauge 110′ printed to a machined pad on the external surface of the hydrocyclone. The hydrocyclone 26 has O-rings 150 located in annular grooves which are arranged to seal in corresponding apertures in the overflow plate 6. A similar arrangement is made in the form of an underflow trunnion with O-rings at the tail pipe end of the hydrocyclone 26. These O rings instead are arranged to seal in apertures in the underflow plate 4. The respective plates abut shoulders 152 formed in the underflow and overflow trunnions.

In view of the need to seal the three chambers of the separator it is necessary to come to some arrangement to allow the signal from the strain gauge 110′ to be “extracted” from the inlet chamber. It will be noted that the chamber is effectively a sealed metallic case which makes radio transmission from inside the chamber to an externally mounted antenna difficult.

Thus one solution is to bring a wired connection through from the inlet chamber to the overflow chamber. This must be done in a mechanically secure way to avoid damaging the wire and also in a way which does not damage the sealing properties between a hydrocyclone and the reject plate.

The solution proposed here is to take a wire 153 over the outer surface of the taper and inlet housing part of the hydrocyclone 26 up to a wire guide hole 154. The wire 153 may be surface mounted over the taper and inlet housing or, preferably, located in a machined groove on the outer surface 156. The wire is bonded for mechanical security using an epoxy resin as discussed elsewhere.

The wire 153 then passes through the guide hole along a passage 158 into the internal surface of the hydrocyclone, in the area marked 160 in FIG. 4. This allows for the wire 153 to pass inside the hydrocyclone and under the O-rings thus allowing a good quality seal to be maintained by the O-rings with the reject plate 6.

The wire 153 then exits through exit slot 162 and may then be multiplexed to a receiver in the overflow chamber 8 (not shown). This provides a neat and robust solution to the challenge of allowing signals to be extracted from the strain gauges in what is undoubtedly a difficult electrical environment.

Thus wired connections from the hydrocyclone to the outside of the pressure vessel or a chamber, may be achieved by providing one or several, shallow channels in the hydrocyclone outer wall in which low profile wires are laid. The wires may also be surface mounted without channels being required.

An ASIC with an IEC61158 network as described above may only need a single, small twisted pair for each hydrocyclone and thus the wires may readily be laid in the channel and under the existing sealing o-rings to be brought out at one end of the pressure vessel.

Alternatively, the data signal may be retrieved from the pressure vessel wirelessly. With reference to FIG. 4, in this arrangement, a pressure vessel 301 includes a wireless transceiver 302, provided typically inside the overflow chamber 8. The transceiver includes an antenna 302a positioned inside the pressure vessel for receiving the data signal from a wireless transceiver 125 of the strain gauge 110, and further includes an antenna 302b for transmitting the data signal outside the pressure vessel. In this arrangement, a data analysis means 250 includes a wireless transceiver 251 for receiving the data signal from the pressure vessel 301. It will be appreciated that any of the wireless communication loops could be optionally replaced with a wired loop.

The data analysis means is not limited to collecting and analysing data from a single pressure vessel. Indeed, the data analysis means could be connected to a plurality of pressure vessels including either a single hydrocyclone 101 or a plurality of hydrocyclones 101, by any of the means discussed above, for transmitting the data signal out of the pressure vessel.

In an arrangement in which the pressure vessel includes a plurality of hydrocyclones 101, it is typically only necessary to include the strain gauges 110 on one or several of the plurality of hydrocyclones 101. The optimal choice of hydrocyclone 101 for the placement of the strain gauges 110 thereon will be determined by factors such as the pressure vessel orientation and the position and size of the flow entry. Typically hydrocylones located towards the bottom of the pressure vessel will exhibit the highest wear since the abrasive solids in the input mixture will tend to have higher concentrations in the lower levels through gravitational effects. Also, hydrocylones near the inlet will provide a noisier output from the strain gauges because of the effect of the inlet flow. Thus typically it is desired to instrument hydrocylones some distance away from the inlet and spread through different height ranges to provide comparative data across areas of anticipated different wear rates. With this knowledge, it is possible to be systematic in selecting where and how many hydrocyclones are instrumented. This reduces the amount of apparatus needed to instrument the hydrocyclones and for transmitting the data signal out of the pressure vessel. However, a greater number of instrumented hydrocyclones is generally good because it provides better scope for comparisons of wear rates in the same vessel and redundancy of components. Thus there is a trade-off between cost-saving and accuracy and speed of fault detection as explained in more detail below.

The data analysis means collects and analyses the data signal, or multiple data signals, in order to determine whether the hydrocyclone 101 is good or eroded. Each strain gauge 110 may provide continuous, real-time data to the data analysis means or data may be stored locally and transmitted in batches or the hydrocyclones may only be sampled periodically. The data analysis means must then process this data to determine if a fault condition exists or to provide other analyses such as when such a condition may occur or how much operational life is left for the hydrocyclones within the pressure vessel.

When a hydrocyclone 101 is new or substantially unworn and is therefore at optimal efficiency and in a ‘good’ state as defined above, strain gauges 110 on the good hydrocyclone 101 provide data signals representative of a physical parameter of the good hydrocyclone 101, and the data analysis means may compile a signature frequency spectrum using the data signals. This spectrum is known as the ‘good spectrum’. This may be used as a benchmark. However testing has shown that even without any wear, the shape of this spectrum varies with operational characteristics of the separator. For example a higher differential pressure across the pressure vessel, with correspondingly higher flow rates, tends to introduce higher frequency energy into the monitored spectrum of vibrations.

Since in normal operation, differential pressure may vary over relatively short timescales, a simple monitoring and differencing of a current spectrum with a measured good spectrum is prone to raise false alarms. Thus several techniques are discussed below which may be used in any combination to enhance the accuracy of fault detection and condition monitoring.

With reference to FIGS. 5a to 5c, the first method is suitable for wear detection in hydrocyclones 101 for separating oil from water and experiencing low differential pressures, for example, 3 bar (300 kPa) inlet to underflow.

When at its operational site, the data analysis means samples the data signals from the hydrocyclone 101 at an appropriate rate. The data analysis means may incorporate any of a number of techniques to reduce the signal to noise ratio of the data but typically compiles an operational spectrum of the collected data signals, for example using a Fast-Fourier Transform (FFT) algorithm, which is used preferably to produce a frequency energy density spectrum of the collected data signal.

The data analysis means then compares the operational spectrum to the good spectrum signature over a predetermined frequency range, e.g. 100 Hz to 900 Hz. To determine if the hydrocyclone 101 has deteriorated from a good state to an eroded state, the data analysis means determines if the current spectrum is different from the good signature by a predetermined amount. This amount or threshold may be set on the particular hydrocyclone 101, based for example, on its dimensions, its environment and particular process conditions and can be determined either through further calibration, e.g. performing the first method on a previously eroded hydrocyclone 101 to compile and store a bad signature spectrum from an eroded hydrocyclone 101, or through calculation. It will be appreciated that a separator vessel will typically be attached rigidly to a steel platform which also carries other high power, vibrating structures such as large motors and the platform drill itself. The platform structure is an effective transmitter of vibrations, which will readily be carried through to the hydrocylones being monitored inside the pressure vessel. The use of such calibrated spectra then readily allows noise from these other sources to be largely excluded from consideration.

The comparison with thresholds will typically be carried out for energy density in particular frequency bands. This may be made with reference to a known good spectrum, measured before wear has taken place.

Using appropriate weightings, bands of the spectrum known to contain useful information on wear can be given greater prominence. This also helps mitigate the effect of extraneous noise from other sources as described above, which usually has dominant frequency harmonics outside the frequency bands given a high weighting.

As explained below, the weighting given to a particular frequency band may be adjusted based on the differential pressure across the separator.

With reference to FIGS. 6a to 6c, the second method is suitable for wear detection in a hydrocyclone 101 experiencing higher differential pressures, e.g. 10 bar (1 MPa) or more inlet to underflow.

As before, the data analysis means receives the data signals from the hydrocyclone 101. The data analysis means compiles an operational spectrum of the collected data signals. The data analysis means then compares the operational spectrum to the good spectrum signature.

The data analysis means determines if the hydrocyclone 101 has deteriorated from a good state to an eroded state typically by determining if there is an extra peak or peaks, in a frequency range of the operational spectrum which does not appear in the good spectrum or if the peaks have shifted in frequency relative to the good spectrum, which might indicate a reduction in stiffness of the hydrocyclone. This is carried out in the same way as method one.

Typically wear thins the hydrocyclone wall, often in an uneven manner, which increases throughput and raises turbulence levels. This typically results in higher vibrational energy density in particular frequency bands being sensed by the strain gauges, compared to a new, unworn hydrocyclone as shown in plot 6b. This increased energy density is shown in the plot of FIG. 6c which is based on real experimental data. The extra peak in this example, can be distinguished as having a predetermined prominence over the background noise. At higher differential pressures, peaks indicating wear, typically occur at higher frequencies as shown in the Figure. Thus additional statistical weighting may be given to higher frequency ranges at higher differential pressures.

A hybrid of the two methods above may be developed in which differential pressure indications are supplied to the data analysis means. The data analysis means may then adjust the weighting given to energy peaks in different bands of the measured vibration spectrum dependent on the differential pressure across the vessel, before arriving at an indication of the level of wear or potential for failure.

Thus the data analysis means may operate in a closed loop fashion in which flow and/or differential pressure measurements are fed back into the algorithm used by the data analysis means, to adjust what type of analysis is carried out on the frequency domain data of vibration; the general trend being that higher differential pressure means that the frequency spectrum at higher frequencies, e.g. between 200 Hz and 900 Hz is of more interest and therefore given a higher statistical weighting. Furthermore, the region between 400 Hz and 900 Hz may be given even greater statistical weighting.

This method may be developed further by only taking strain gauge readings at times when particular discrete differential pressures occur. This means that a set of readings at the same discrete differential pressure values can be developed over time which allows good time varying comparisons to be made whilst normalising the readings for differential pressure.

Whilst flow through a pressure vessel generally splits fairly evenly between the hydrocylones contained within it, the solids distribution is typically non-uniform and thus some hydrocyclones wear quicker than others. Thus as a further enhancement, it is desirable to measure several hydrocyclones in a vessel and preferably to have a control hydrocyclone which is located in a position which is known to experience the least wear in operation, for example away from the sides of the pressure vessel and generally towards the top. Thus wear may be determined by comparing readings across an array of hydrocyclones. Since all the hydrocyclones are located in the same vessel, they will generally experience the same process conditions. A comparison of readings taken at the same time will therefore inherently be normalised over the instantaneous operating conditions meaning that anomalous readings from a hydrocyclone or group of hydrocyclones are very likely to indicate a difference in internal geometry for those hydrocyclones, which in turn indicates wear. Spectral analysis of those hydrocyclones as described above, may then be used to determine whether the wear is critical.

The best readings will be achieved by monitoring every hydrocyclone in a vessel. However, effective monitoring can still be achieved by using only a selected sample of hydrocyclones which significantly reduces the complexity and cost of the installation for each pressure vessel.

This wear detection algorithm may be self-learning so that wear across the hydrocyclone array is compared over a relatively short period e.g. a few weeks or months, whilst longer term operational variations are gradually cancelled out as older data readings are slowly flushed through in an automatic data ageing process. The period of aging must be selected so that long-term wear effects are properly accounted for and detected.

Historical data may also be used to assess the trend of wear and deterioration over time, and thus the data analysis means may provide a prediction of when maintenance may be required.

Experimental data produced in the Applicant's research will now be discussed with reference to FIGS. 7a and 7b. A pressure vessel was fitted with three hydrocyclones, i.e. a new hydrocyclone (in a ‘good’ state) C08, a semi-eroded hydrocyclone E09, and a substantially eroded hydrocyclone E10. Strain gauges were applied to each hydrocyclone, and a test run was performed, using a frequency band between 200 Hz and 8000 Hz.

The sampling frequency for recording strain was 20 kHz and 8192 samples were used to generate each FFT screen (see FIG. 7a). A Cyclone Damage Unit (CDU) is defined for each liner. The CDU is the integrated power spectral density and reflects the strain intensity within that frequency range.

FIG. 7b shows CDU values plotted for each screen during a 3 bar (300 kPa) test. The results are normal distributed, and mean and standard deviations are logged on the plot. The plot shows that as cyclone wear increases, the mean CDU value increases. Also, it shows that the standard deviation also increases with cyclone wear. This suggests that the damage to the cyclone weakens the structure and introduces not only more vibrations but vibrational modes that are less stable.

The experimental data thus confirms that a strain gauge can differentiate between different degrees of hydrocyclone wear by analysis of the spectral density of the strain gauge output over a certain frequency range.

The skilled reader will understand that the data analysis methods described above, can be applied to data signals provided by strain gauges 110 on hydrocyclones 101 in any one of the pressure vessels detailed above.

The skilled reader will appreciate that the use of strain gauges is appropriate for detecting wear in hydrocyclones. The prior art (such as International patent application no. 01/03840 A1) used acoustic measuring techniques. However, the low acoustic output from the passage of fluid (having trace levels of suspended solids) through a hydrocyclone in a flooded pressure vessel (which would dampen any acoustic output) makes acoustic monitoring techniques unsuitable for the hydrocyclone. Thus, the use of a strain gauge is an effective alternative to acoustic monitoring for detecting structural borne vibration of the/each hydrocyclone.

The skilled reader will understand that any combination of features is possible without departing from the scope of the invention, as claimed.

1. A wear detector arranged to detect wear in a hydrocyclone in a pressure vessel, comprising
a strain gauge mounted to the hydrocyclone and arranged to sense vibration of the hydrocyclone in use, and
a signal processor coupled to the strain gauge and arranged to sample the strain gauge output to provide strain gauge data representative of the vibration experienced by the strain gauge as fluid flows through the hydrocyclone,
the signal processor being further arranged to generate a current frequency signature for the hydrocyclone by analysing the strain gauge data to determine the energy density in a plurality of vibrational frequency bands, to provide an indication of the degree of wear on the internal surfaces of the hydrocyclone.

2. A wear detector according to claim 1 wherein the signal analyser is arranged to store a historic frequency signature for the hydrocyclone and to compare it with the current frequency signature to determine the degree of wear.

3. A wear detector according to claim 1 or claim 2, wherein the signal processor is arranged to provide different statistical weightings to different respective frequency bands.

4. A wear detector according to any preceding claim wherein the strain gauge is a thick film piezoresistive strain gauge printed on an external surface of the hydrocyclone.

5. A wear detector according to any preceding claim, further comprising a differential pressure transducer for sensing differential pressure across the pressure vessel, coupled to the signal processor and wherein the signal processor is arranged to give a higher statistical weighting to the frequency bands at higher frequencies with increasing differential pressure.

6. A wear detector according to claim 5 wherein at differential pressures below 3 bar (300 kPa) inlet to underflow, the signal processor is arranged to give the frequency range in the current frequency signature, from 100 Hz to 900 Hz greatest statistical weighting.

7. A wear detector according to claim 5 or claim 6, wherein at differential pressures above 10 bar (1 MPa) inlet to underflow, the signal processor is arranged to give the frequency range in the current frequency signature, from 200 Hz to 900 Hz greatest statistical weighting.

8. A wear detector according to claim 7, wherein the region from 400 Hz to 900 Hz is given even greater statistical weighting.

9. A wear detector according to any preceding claim, comprising a plurality of strain gauges mounted to a plurality of respective hydrocylones in the process vessel and wherein the signal processor is further arranged to compare hydrocyclone frequency signatures between the hydrocylones to determine the relative degree of wear between the hydrocyclones.

10. A wear detector according to claim 9, wherein the comparison between hydrocyclone frequency signatures is made with reference to the frequency signature of a hydrocyclone located in the process vessel in a position known to exhibit low wear.

11. A wear detector according to any preceding claim wherein a plurality of strain gauges are mounted on the or each hydrocyclone.

12. A wear detector according to claim 11 wherein the outputs of the strain gauges are multiplexed together on the hydrocyclone before onward transmission to the signal processor.

13. A wear detector according to any preceding claim, wherein pre-processing of the strain gauge output is carried out by a local signal processing means mounted on the hydrocyclone or located in the same chamber of the pressure vessel as the hydrocyclone.

14. A method of detecting wear in a hydrocyclone in a pressure vessel, comprising the steps of analysing the signal from a strain gauge mounted to the hydrocyclone to sense vibration of the hydrocyclone as energy is imparted to it by fluid flowing through it in use, sampling the strain gauge output to provide strain gauge data representative of the vibration experienced by the strain gauge as fluid flows through the hydrocyclone, generating a current frequency signature for the hydrocyclone by analysing the strain gauge data to determine the energy density in a plurality of vibrational frequency bands, and providing an indication of the degree of wear on the internal surfaces of the hydrocyclone based on the current frequency signature.

15. A computer readable medium having computer-executable instructions stored thereon for performing the steps of claim 14.

16. A wear detector substantially as herein described with reference to and as shown in any combination of the accompanying drawings.

17. A method substantially as herein described with reference to and as shown in any combination of the accompanying drawings.

18. A hydrocyclone substantially as herein described with reference to and as shown in any combination of the accompanying drawings.
